(19) United States
(12) Patent Application Publication
(10) Pub. No.: US 2019/0107362 A1
(43) Pub. Date: Apr. 11, 2019

(54) VELOCITY ALIGNED THROWABLE OBJECT

(71) Applicant: Gary Makowski, Huntsville, AL (US)

(72) Inventor: Gary Makowski, Huntsville, AL (US)

(21) Appl. No.: 16/212,472

(22) Filed: Dec. 6, 2018

Related U.S. Application Data
(62) Division of application No. 15/229,488, filed on Aug. 5, 2016.
Application No. 15/229,488 is a continuation-in-part of application No. 13/827,672, filed on Mar. 14, 2013, now Pat. No. 9,506,719.

(51) Int. Cl. F41B 15/00; B26B 1/04; B26B 23/00

(52) U.S. Cl. CPC F41B 15/00; B26B 23/00; B26B 1/044

(57) ABSTRACT

A VATO comprises a blade, a handle, a stabilizing assembly, and a spherical weight. In a preferred embodiment, the spherical weight makes up a significant portion of the overall weight of the VATO. The spherical weight is positioned between the blade and the handle, and the stabilizing assembly is attached to a rear portion of the handle. When the VATO is thrown, a velocity vector is established in the direction of the trajectory of the VATO. The stabilizing assembly produces aerodynamic drag which assists in keeping the blade oriented in a forward position with respect to the trajectory of the VATO. The spherical weight is permitted to freely rotate thereby enabling the blade, the handle and the stabilizing assembly to independently rotate into alignment with the trajectory of the VATO such that the blade is in a forward position as the VATO strikes a target.

### CROSS-REFERENCE TO RELATED APPLICATIONS

This application is a divisional of U.S. patent application Ser. No. 15/229,488 entitled Velocity Aligned Throwable Object and filed on Aug. 5, 2016, which is a continuation-in-part of U.S. Pat. No. 9,506,719 entitled Velocity Aligned Throwable Object and filed on Mar. 14, 2013, both of which are incorporated by reference as if fully set forth herein.

### BACKGROUND

This invention generally relates to weapons. In particular, the present invention relates to knives and axes. More particularly, the present invention relates to knives and axes which may be thrown in an unorthodox method similar to that of throwing a dart or a spear.

Conventional knives and axes are thrown at a target by rotating the Knife or axe end over end through the air such that the blade is facing the target at the point of contact. Great skill is required to consistently hit the target with the blade due to the difficulty of achieving the proper velocity and the proper number of rotations in order to ensure that the blade penetrates the target from a given distance. However, users with little skill or experience have a difficult time consistently hitting the target with the blade such that the blade remains in the target. Such users frequently hit the target with the side of the blade or with the handle of the Knife or axe due to the inability of the conventional knives and axes to stabilize themselves in flight with the blade facing the target.

### SUMMARY OF THE INVENTION

The present disclosure is directed to a velocity aligned throwable object (VATO). An exemplary VATO of the present disclosure has a blade, a spherical weight, a handle, and a rear stabilizing assembly. In one embodiment, the spherical weight comprises a significant portion of the weight of the VATO, and the spherical weight freely rotates with respect to the blade, handle and rear stabilizing assembly in order to maintain proper orientation of the VATO.

In one exemplary embodiment, the spherical weight is positioned between the blade and the handle, and the stabilizing assembly is attached to a rear portion of the handle. When the VATO is thrown, a velocity vector is established in the direction of the trajectory of the VATO. The stabilizing assembly produces aerodynamic drag which assists in keeping the blade oriented in a forward position with respect to the trajectory of the VATO. The spherical weight is permitted to freely rotate thereby enabling the blade, the handle and the stabilizing assembly to independently rotate into alignment with the trajectory of the VATO such that the blade is in a forward position as the VATO strikes a target.

Additional objects and advantages of the apparatuses are set forth in, or will be apparent to those of ordinary skill in the art from, the detailed description as follows. Also, it should be further appreciated that modifications and variations to the specifically illustrated and discussed features and materials hereof may be practiced in various embodiments and uses of these apparatuses without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a side view of an exemplary embodiment of a VATO.

FIG. 2 depicts a side view of the blade and the handle of the VATO of FIG. 1.

FIG. 3 depicts a side view of the VATO of FIG. 1 with the stabilizing assembly and the retaining piece removed.

FIG. 4 depicts a side view of an exemplary embodiment of the VATO of FIG. 1 having a modified blade.

FIG. 5 depicts a side view of an exemplary embodiment of a VATO according to another aspect of the present disclosure.

FIG. 6 depicts a side view of the handle and the spherical weight of the VATO of FIG. 5.

FIG. 7 depicts a side view of an exemplary embodiment of a VATO according to another aspect of the present disclosure in an open position.

FIG. 8 depicts a side view of the VATO of FIG. 7 in a closed position.

FIG. 9 depicts a side view of the blade assembly of the VATO of FIG. 7.

FIG. 10 depicts a top view of the blade assembly of the VATO of FIG. 7.

FIG. 11 depicts a perspective view of the handle assembly of the VATO of FIG. 7.

FIG. 12 depicts a front view of the spherical weight and the handle assembly of FIG. 7.

FIG. 13 depicts a side view of the spherical weight of FIG. 7 retained within the handle assembly by the retaining piece.

FIG. 14 depicts a perspective view of the locking device of FIG. 7.

FIG. 15 depicts a bottom view of the VATO of FIG. 7 with the blade assembly in an open position.

FIG. 16 depicts a bottom view of the VATO of FIG. 7 with the locking device bent away from the handle assembly.

FIG. 17 depicts a side view of an exemplary VATO according to another aspect of the present disclosure.

FIG. 18 depicts a side view of the axe frame assembly of FIG. 17.

FIG. 19 depicts a side view of the VATO of FIG. 17 with the stabilizing assembly removed.

FIG. 20 depicts a side view of the VATO of FIG. 17 with the stabilizing assembly in a stowed position;

FIG. 21 is a side view of an exemplary VATO knife structure according to a further embodiment;

FIG. 22 is another side view of the VATO knife of FIG. 21 showing an attachment member;

FIG. 23 depicts the VATO knife of FIG. 22 with the attachment member extended toward the rear;

FIG. 24A is a view of the rear of the handle of the VATO knife of FIG. 22;

FIG. 24B is a section view of the handle of the VATO knife of FIG. 22;

FIG. 25 is an exemplary VATO knife with a drogue chute attached;

FIG. 26 shows the exemplary VATO knife with a handle covering;

FIG. 27 depicts another exemplary attachment member for use with another embodiment of the VATO knife;

FIG. 28 illustrates yet another exemplary embodiment of a VATO knife;

FIG. 29 is a fragmentary view of the rearward end of the handle of the VATO knife of FIG. 28; and

FIG. 30 is another exemplary embodiment of a VATO axe.

### DETAILED DESCRIPTION

In the present disclosure “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

For purposes of description herein, the terms of direction, such as, “upper,” “lower,” “top,” “bottom,” “right,” “left,” “rear,” “front,” “vertical,” “horizontal,” and derivatives, or synonyms thereof, shall be understood to be oriented with respect to the body of the knife or axe described. “Rear” shall mean in the direction of a handle of the knife or axe, while “front” shall mean toward the blade or axe head. “Top” and “bottom” of the knife shall be with reference to a plane defined by the edges of the knife blade for the knife embodiments described below. For the axe, it will be assumed, unless specified otherwise, that the axe blade will be oriented downward. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 depicts a side view of an exemplary embodiment of a velocity aligned throwable object (VATO) 10. The VATO knife 10 comprises a blade 12, a handle 14, a rear stabilizing assembly 15, and a spherical weight 18. In one embodiment, the blade 12 and handle 14 are formed from one solid piece of material, such as, for example steel. However, in other embodiments, the blade 12 and the handle 14 may be formed from multiple pieces of material and coupled together via fasteners (not shown).

The handle 14 and blade 12 may be used in conventional matter, for example for cutting, carving or slicing. As shown by FIG. 1, the VATO knife 10 has an opening 20 for receiving the spherical weight 18. In one embodiment, the opening 20 is positioned between the blade 12 and the handle 14, although other locations for the opening 20 are possible in other embodiments. The spherical weight 18 is maintained within the opening 20 by one or more retaining pieces 22. In one embodiment, the retaining pieces 22 are made of a flexible metal or other similar material, which may be easily bent yet rigid enough to support the spherical weight 18. In the embodiment depicted, the retaining pieces 22 are crossed diagonal over the spherical weight 18; however, the retaining pieces 22 may be oriented with respect to the spherical weight in different orientations in other embodiments.

In one embodiment, the retaining pieces 22 are secured to the VATO knife 10 by looping the pieces 22 through one or more eyelets 24 which are positioned on the VATO knife 10. However, other means for securing the retaining pieces 22 to the VATO knife 10 are possible in other embodiments. Note that FIG. 1 depicts four (4) eyelets 24 positioned squarely around the opening 20; however, the VATO may comprise more or fewer eyelets 24, and the eyelets 24 may be positioned differently in other embodiments.

The rear stabilizing assembly 15 is attached to a rear portion of the handle 14. When in a deployed position, as shown by FIG. 1, the rear stabilizing assembly 15 stabilizes the blade 12 and handle 14 by producing aerodynamic drag such that the blade 12 remains oriented in a forward position relative to the trajectory of the VATO knife 10. Thus, when the VATO knife 10 is thrown, the blade 12, handle 14 and stabilizing assembly 15 rotate independently from the spherical weight 18 based on aerodynamic drag thereby ensuring that the blade 12 is in a forward position relative to the direction the VATO knife 10 is traveling. Even if the VATO knife 10 is thrown such that the blade 12 is initially in a rear position relative to the trajectory of the VATO knife 10, the stabilizing assembly 15 will correct the orientation of the blade 12 such that the blade 12 is adjusted to the forward position.

Note that in one embodiment, the rear stabilizing assembly 15 comprises cloth or other flexible material that provides aerodynamic stability. However, the rear stabilizing assembly 15 may comprise other structures and may be comprised of other types of material in other embodiments. For example, the rear stabilizing assembly 15 may comprise collapsible fins, rudders, arrow fletchings, wings or the handle 14.

In one embodiment, the spherical weight 18 makes up a substantial portion of the overall weight of the VATO knife 10 in order to allow rapid alignment of the other components of the VATO knife 10. The spherical weight 18 also rotates within the opening 20 independently from the other components of the VATO knife 10. Thus, the trajectory of the spherical weight 18 dictates the trajectory of the VATO knife 10 as well as the orientation of the blade 12 as it approaches a target (not shown). Accordingly, the blade 12 is oriented towards the target upon impact.

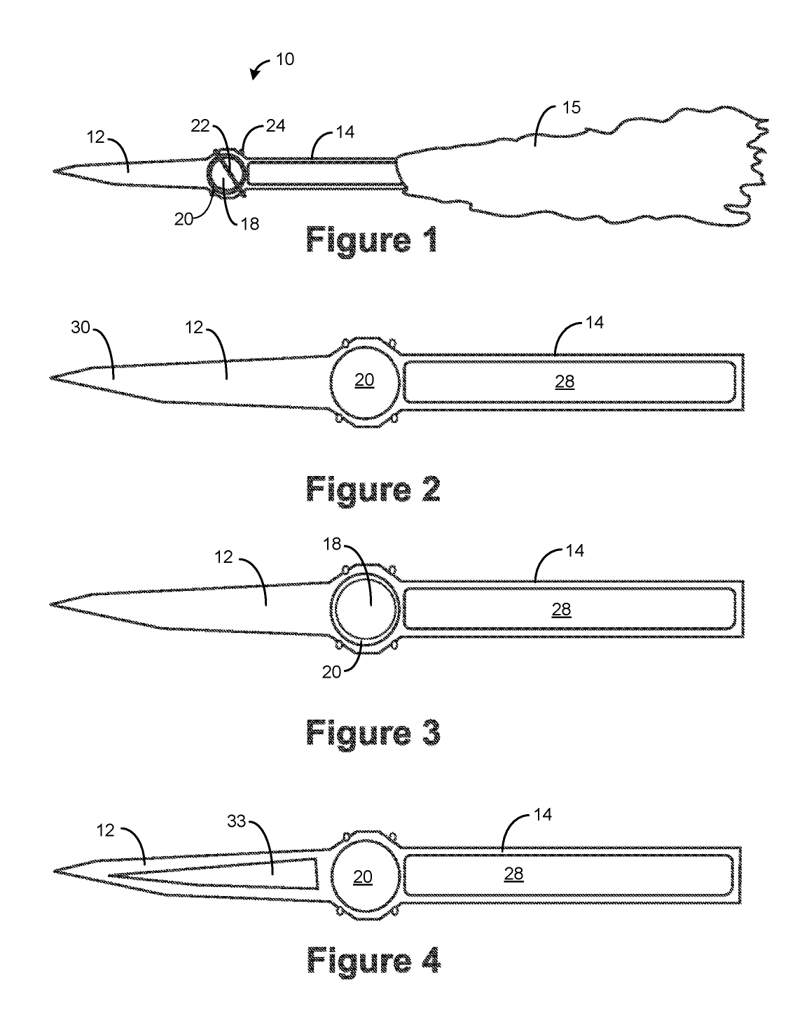

FIG. 2 depicts a side view of an exemplary embodiment of the blade 12 and handle 14 of the VATO knife 10 (FIG. 1). As described hereinabove, the blade 12 and handle 14 may be formed from one solid piece of material, such as, for example, steel. The blade 12 is formed into a sharp point 30 for piercing a target (not shown) and may have at least one sharp edge for cutting, carving, and/or slicing.

In the embodiment depicted, the handle 14 is generally rectangular in shape, although other shapes are possible in other embodiments. In one embodiment, the handle 14 has a large elongated rectangular opening 28 extending from side to side through the handle 14 in order to reduce the weight of the handle 14. Reducing the weight of the handle 14 results in the spherical weight 18 (FIG. 1) constituting a significant portion of the overall weight of the VATO knife 10. Note that the blade 12 and the handle 14 may have different sizes and shapes in other embodiments.

The opening 20 is located between the blade 12 and the handle 14 and extends from side to side through the VATO knife 10. The opening 20 receives the spherical weight 18. The eyelets 24 are positioned in relatively close proximity to the opening 20 in order to receive the retaining pieces 22 (FIG. 1) and enclose the spherical weight 18 within the opening 20. While four eyelets 24 are shown in FIG. 2, other numbers of eyelets 24 are possible in other embodiments.

FIG. 3 depicts a side view of the VATO knife 10 of FIG. 1 with the stabilizing assembly 15 and the retaining piece 22 removed. As shown by FIG. 3, the spherical weight 18 is positioned within the opening 20. The spherical weight 18 may comprise any weighted object that is generally spherical in shape, such as, for example, a ball bearing or a spherical container filled with liquid. In an alternative embodiment, the spherical weight 18 may be located within a cylindrical container (not shown) positioned within the opening 20. In such embodiment, the spherical weight 18 is loose within the cylindrical container in order to allow the weight 18 to move independently from the other components of the VATO knife 10.

The circumference of the opening 20 is larger than the circumference of the spherical weight 18 such that the weight 18 may freely spin and rotate within the opening 20 independently from the blade 12, handle 14, and stabilizing assembly 15 (FIG. 1) of the VATO knife 10. Thus, as the VATO knife 10 travels through the air, the blade 12, handle 14, and stabilizing assembly 14 independently align themselves with the trajectory of the spherical weight 18 by pivoting about the spherical weight 18. Accordingly, the blade 12 remains in a forward position with respect to the trajectory of the VATO knife 10 while in flight.

FIG. 4 depicts a side view of another exemplary embodiment of the VATO knife 10 (FIG. 1) with the stabilizing assembly 15 and the retaining pieces 22 removed. In the embodiment depicted, the VATO knife 10 of FIG. 4 comprises a blade 12 having an opening 33 extending from side to side through the blade 12. The opening 33 may be any size or shape. The opening 33 decreases the weight of the blade 12 thereby decreasing the overall weight of the VATO knife 10. The decreased weight in the blade 12 enhances the aerodynamic stability of the VATO knife 10 by removing weight from the front of the VATO knife 10 while it is in flight and allowing the blade 12 and the handle 14 to easily adjust to the trajectory of the VATO knife 10. As the weight of the blade 12 and the handle 14 decreases with respect to the weight of the spherical weight 18 (FIG. 1), the ability of the blade 12 and the handle 14 to easily align with the trajectory of the spherical weight 18 (FIG. 1) increases.

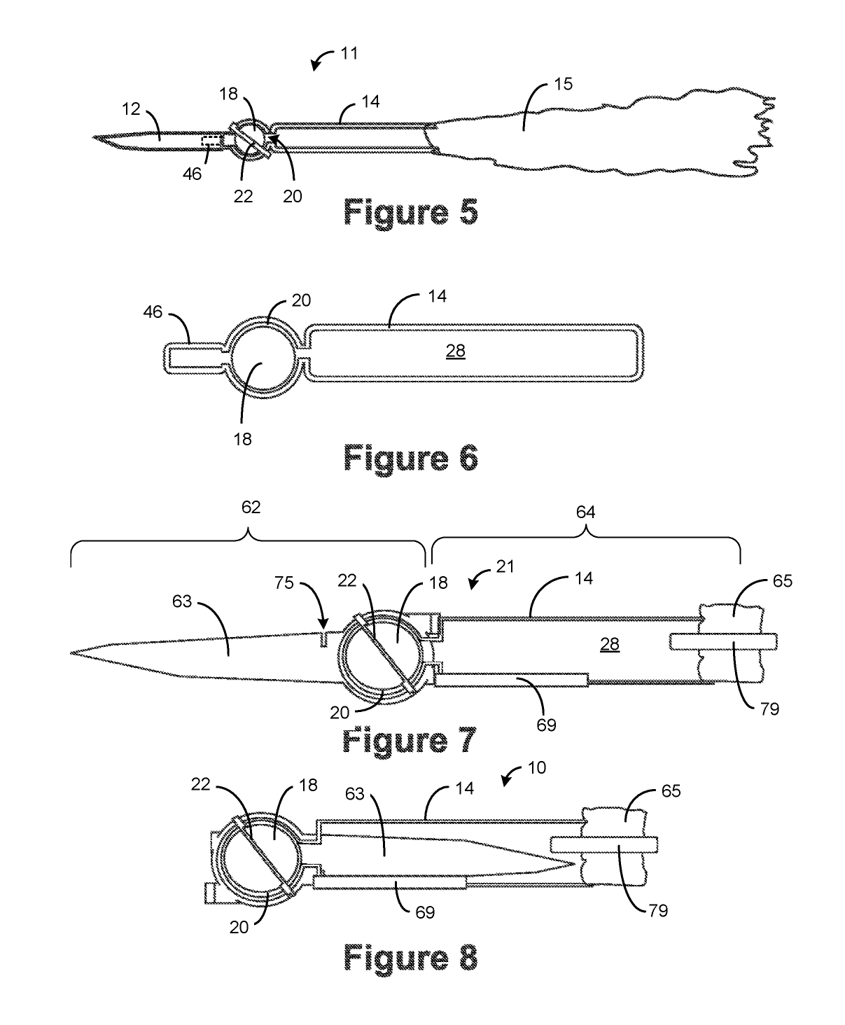

FIG. 5 depicts a side view of another exemplary embodiment of a VATO knife 11. The VATO knife 11 comprises the blade 12, the handle 14, the stabilizing assembly 15, and the spherical weight 18. In this respect, the VATO 11 depicted in FIG. 5 is similar to the VATO 10 depicted in FIG. 1.

However, in regards to the VATO 11, the blade 12 and the handle 14 are formed from separate pieces of material and are coupled together. In this regard, the handle 14 comprises a protrusion 46 for receiving and coupling to the blade 12. Notably, the blade 12 is coupled to the protrusion 46 on the forward end of the handle 14 and the stabilizing assembly 15 is coupled to a rear end of the handle 14. In one embodiment, the blade 12 comprises steel, although other materials are possible in other embodiments. In this embodiment, the handle 14 comprises at least one wire formed into a generally rectangular shape having a circular opening 20 for receiving the spherical weight 18. The handle 14 may comprise steel or any other suitable material.

The spherical weight 18 is retained within the circular opening 20 by the one or more retaining pieces 22. The retaining pieces 22 are made from flexible metal or other similar material which may be easily formed yet strong enough to support the spherical weight 18. In one embodiment, the retaining pieces 22 are bent around portions of the handle 14 on opposing sides of the circular opening 20 in order to retain the spherical weight 18 within the circular opening 20. However, other means for attaching the retaining pieces 22 to the handle 14 are possible in other embodiments.

The stabilizing assembly 15 produces aerodynamic drag thereby allowing components of the VATO knife 10 to rotate about the spherical weight 18 and become aligned such that the blade 12 is in a forward position with respect to the VATO knife 11 during flight. If the blade 12 is not positioned forward with respect to the trajectory of the spherical weight 18 during flight, the stabilizing assembly 15 produces aerodynamic drag and aligns itself in a rearward position with respect to the trajectory. Accordingly, the blade 12 is also adjusted such that the blade 12 is in a positioned forward with respect to the trajectory of the VATO knife 11. If the trajectory of the spherical weight 18 changes during flight, such as, for example, traveling downward due to the force of gravity, the stabilizing assembly 15 realigns itself such that the assembly 14 is in positioned rearward, and the blade 12 is in a positioned forward with respect to the downward trajectory of the spherical weight 18. Thus, the blade 12 remains in positioned forward, and the stabilizing assembly 15 remains in positioned rearward with respect to the trajectory of the VATO knife 11 during flight.

FIG. 6 depicts a side view of the handle 14 and the spherical weight 18 of the VATO knife 11 of FIG. 5. As set forth above, the handle 14 is a frame of wire, such as, for example, steel wire. In one embodiment, the handle 14 is formed from one contiguous piece of wire, although a plurality of wires may be used to form the handle 14 in other embodiments. The handle 14 forms the circular opening 20, and the handle 14 has an integrated coupling piece 46 extending from a forward end of the handle 14. The circular opening 20 receives the spherical weight 18 and the coupling piece 46 couples to the blade 12 (FIG. 5). The circular opening 20 is positioned at a generally central position with respect to the handle 14. Thus, the spherical weight 18 is positioned between the blade 12 and the handle 14. In one embodiment, the spherical weight 18 is positioned to the left of center of the handle 14.

In one embodiment, the coupling piece 46 may be inserted to a slot (not shown) at the base of the blade 12 in order to secure the blade 12 to the coupling piece 46, although other methods of securing the blade 12 to the piece 46 are possible in other embodiments. The stabilizing assembly 15 (FIG. 5) is coupled to a rear portion of the handle 14 when the VATO knife 10 is fully assembled.

FIG. 7 depicts another exemplary embodiment of a VATO knife 21. The VATO knife 21 is depicted in an open position, which means that the blade 12 is extended for use.

The VATO knife 21 comprises a blade assembly 62, a handle assembly 64, a stabilizing assembly 65, a spherical weight 18, and a locking device 69. The blade assembly 62 comprises a blade 63. The blade assembly 62 has the circular opening 20 for receiving the spherical weight 18, and the spherical weight 18 is retained within the circular opening 20 with the one or more retaining pieces 22. In one embodiment, the retaining pieces 22 are secured to the blade assembly 62 by wrapping opposing ends of the pieces 22 around portions of the blade assembly 62 on opposing sides of the circular opening 20. Other means for securing the spherical weight 18 are possible in other embodiments. In the exemplary VATO 21, the blade assembly 62 has one or more slots 75 for receiving the locking device 69 and maintaining the blade assembly 62 in a closed position.

In one embodiment, the handle assembly 64 may be formed from one or more flexible metal wires, discussed in more detail hereafter. However, the handle assembly 64 may be formed from at least one piece of solid material, such as, for example, steel in other embodiments. In one embodiment, the handle assembly 64 comprises a wire mesh cover (not shown). The wire mesh cover protects a user's hand and/or other body parts from injury when the blade assembly 62 is in a closed position, as will be discussed in more detail below. However, other types of covers are possible in other embodiments. A portion of the handle assembly 64 extends around the spherical weight 18 and pivotally engages with the blade assembly 62 in order to allow the blade assembly 62 to rotate about the spherical weight 18.

The stabilizing assembly 65 is coupled to a rear portion of the handle assembly 64. The stabilizing assembly 65 shown in FIG. 7 is in a stowed position and is held in such position with a clip 79. The clip 79 prevents the stabilizing assembly 65 from hanging freely from the handle assembly 64 and interfering with handheld use of the VATO knife 21. When a user desires to throw the VATO knife 21, the user ensures that the blade assembly 62 is in an open position and removes the clip 79 in order to transition the stabilizing assembly 65 to a deployed position. The stabilizing assembly 65 then adjusts the position of the blade assembly 62 with respect to the trajectory of the VATO knife 21 while in flight, as set forth above. Although FIG. 7 depicts the clip 79 for holding the stabilizing assembly 65 in the stowed position, other means for holding the assembly 65 in such position are possible in other embodiments.

FIG. 8 depicts the VATO knife 21 of FIG. 7 with the blade assembly 62 in a closed position. When the blade assembly 62 (FIG. 7) is not in use, the blade assembly 62 may be rotated to a closed position such that the blade 63 is positioned within the handle assembly 64. Such positioning of the blade 63 prevents a user from suffering an injury by preventing contact with the blade. The locking device 69 engages the blade assembly 62 and locks the blade assembly 62 in a closed position in order to prevent the blade 63 from rotating out of the handle assembly 64. Thus, the VATO knife 21 may be safely handled or stored.

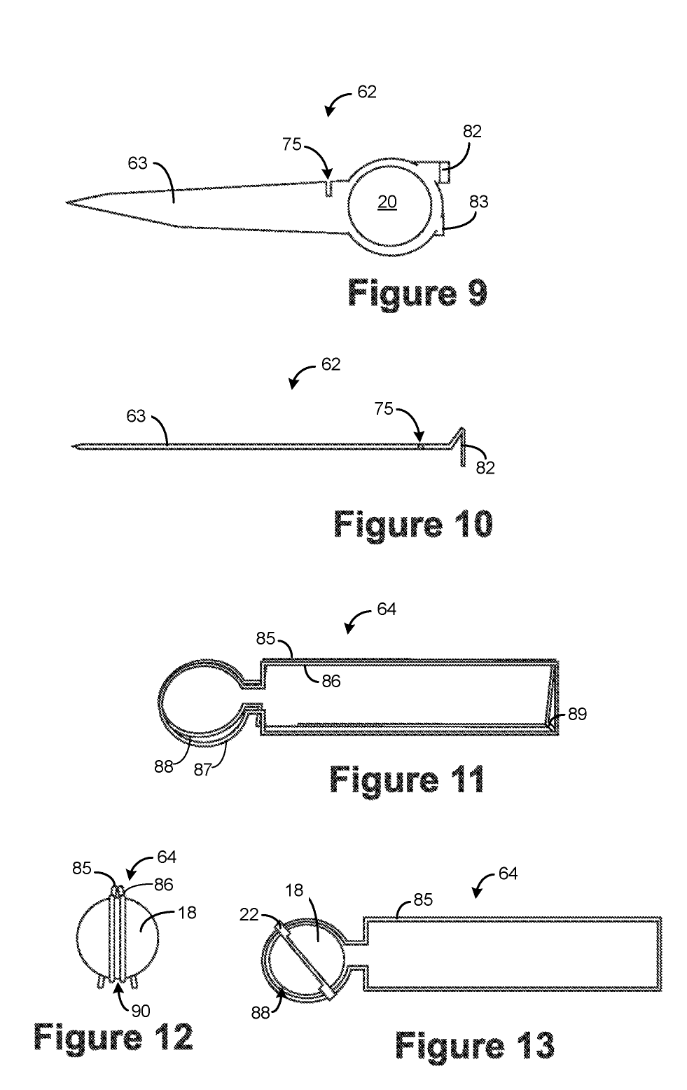

FIG. 9 depicts a side view of an exemplary embodiment of the blade assembly 62 of FIG. 7. The blade assembly 62 comprises the blade 63, an upper blade stop 82, and a lower blade stop 83. The stops 82 and 83 are protrusions that aid in holding the blade 63 in an open position when the VATO 21 is in use.

The blade assembly 62 has the circular opening 20 for receiving the spherical weight 18 (FIG. 7), and the blade 63 has at least one slot 75 for receiving the locking device 69 when the blade assembly 62 is in a closed position. The upper blade stop 82 extends in a generally perpendicular direction to the remainder of the blade assembly 62, and the upper blade stop 82 abuts a portion of the handle assembly 64 (FIG. 7) in order to prevent further rotation of the blade assembly 62 when the assembly 62 is in the open position. The lower blade stop 83 is a substantially flat piece which extends from the handle assembly 64 and abuts the locking device 69 in order to lock the blade assembly 62 in an open position and prevent the blade assembly 62 from rotating back to a closed position. Although the VATO knife 10 of FIG. 9 depicts the upper blade stop 82 and the lower blade stop 83, other means for locking the blade assembly 62 in open and closed positions are possible in other embodiments.

FIG. 10 depicts a top view of the blade assembly 62 of FIG. 7. The upper blade stop 82 is oriented in a generally perpendicular position with respect to the blade 63. Such orientation allows the upper blade stop 82 to rest against a portion of the handle assembly 64 and to prevent further rotation of the blade assembly 62 when the blade assembly 62 is in the open position. The slot 75 extends down into the blade 63 from the top of the blade 63 in order to allow the locking device 69 to lock the blade assembly 62 in the closed position.

FIG. 11 depicts a perspective view of the handle assembly 64 of FIG. 7. The handle assembly 64 comprises at least one wire frame member 85 having an opening 87 at a forward end of the handle assembly 64 for receiving the spherical weight 18 (FIG. 7). In one embodiment, the handle assembly 64 comprises two steel wire frame members 85 and 86. Wire frame member 86 comprises an opening 88 at a forward end of the handle assembly for receiving the spherical weight 18 (FIG. 7).

The blade assembly 62 (FIG. 9) engages with the forward end of the handle assembly 64 such that the circular opening aligns with the opening 88 and the blade assembly 62 may rotate about the spherical weight 18. In one embodiment, a rear end of the blade assembly 62 is positioned between forward ends of opposing wire frame members 85 of the handle assembly 64. In such embodiment, the blade assembly 62 may be rotated about the spherical weight 18 such that the blade 63 (FIG. 7) is positioned between the wire frame members 85 when the blade assembly 62 is in the closed position. Other means for engaging the blade assembly 62 with the handle assembly 64 are possible in other embodiments.

In one embodiment, the handle assembly 64 further comprises a cross brace 89 for coupling rear ends of the wire frame members 85 and 86 to one another. However, in another embodiment, the handle assembly 64 may be formed from one contiguous wire frame member having two sides. Other handle assembly configurations are possible in other embodiments.

FIG. 12 depicts a front view of the spherical weight 18 of FIG. 7 positioned within the openings 87 and 88 (FIG. 11) of the wire frame members 85 and 86. The wire frame members 85 and 86 of the handle assembly 64 meet at their tops and extend downwardly away from one another such that the wire frame members 85 and 86 are separated by a gap 90. The spherical weight 18 is positioned within the openings 87 and 88 of the wire frame members 85 and 86. The blade assembly 62 (FIG. 7) is positioned within the gap 90 and pivots about the spherical weight 18 in order to allow the blade assembly 62 to transition between the open and closed positions.

FIG. 13 depicts a side view of the spherical weight 18 retained within the openings 87 and 88 of the wire frame members 85 and 86 with a retaining piece 22, as is depicted by FIG. 7. The wire frame members 85 and 86 of the handle assembly 64 may be formed into any desirable shape suitable for gripping. The wire frame members 85 and 86 have circular front portions having the openings 87 and 88 for receiving the spherical weight 18. The diameter of the openings 87 and 88 are larger than the diameter of the spherical weight 18 in order to provide room for the weight 18 to spin and rotate independently. The retaining piece 22 is secured to the wire frame members 85 and 86 and retains the spherical weight 18 within the openings 87 and 88. In one embodiment, the retaining piece 22, such as, for example, a flexible wire rod, is secured to the wire frame members 85 and 86 by wrapping opposing ends of the retaining piece 22 around the member 85 on opposing sides of the opening 88. However, other means for securing the weight 18 within the openings 87 and 88 are possible in other embodiments.

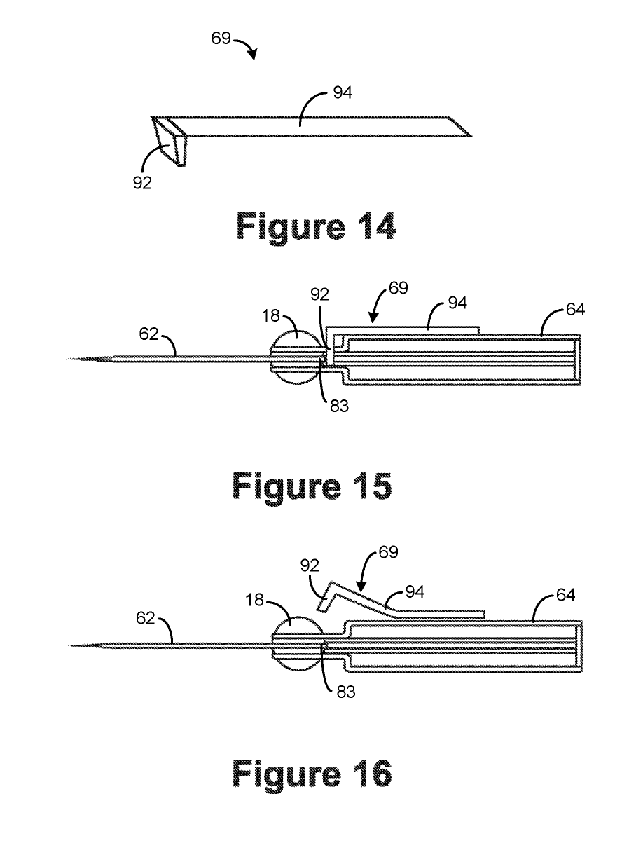

FIG. 14 depicts a top perspective view of an exemplary embodiment of a locking device 69, such as is depicted by FIG. 7. In one embodiment, the locking device 69 comprises a flat protrusion 92 extending in a generally perpendicular direction from an end of a flexible mounting strip 94. An opposing end of the mounting strip 94 is coupled to the handle assembly 64 (FIG. 7) such that the protrusion 92 abuts the lower blade stop 83 when the blade assembly 62 (FIG. 7) is in the open position. When adjusting the position of the blade assembly 62 is desired, the mounting strip 94 may bend such that the protrusion 92 no longer abuts the lower blade stop 83 and the blade assembly 62 may rotate. When the blade assembly 62 is in the closed position, the protrusion 92 is inserted into the slot 75 (FIG. 7) in order to lock the blade assembly 62 in the closed position. The mounting strip 94 may bend in order to remove the protrusion 92 from the slot 75 and again adjust the position of the blade assembly 62, as may be desired.

FIGS. 15 and 16 depict bottom views of the VATO knife 10 of FIG. 7. FIG. 15 depicts a bottom view of the VATO knife 10 of FIG. 7 with the blade assembly 62 locked in the open position. Note that both the blade assembly 62 and the handle assembly 64 receive the spherical weight 18. The locking device 69 is mounted to the handle assembly 64 such that the protrusion 92 abuts the lower blade stop 83 thereby preventing rotation of the blade assembly 62 and locking the blade assembly 62 in the open position. When adjusting the position of the blade assembly 62 to the closed position is desired, the mounting strip 94 may be bent away from the handle assembly 64 such that the protrusion 92 no longer abuts the lower blade stop 83, as shown by FIG. 16. The blade assembly 62 may then be pivoted about the spherical weight 18 to the closed position and the protrusion 92 may be inserted into the slot 75 (FIG. 7) to lock the assembly 62 in the closed position, as set forth above.

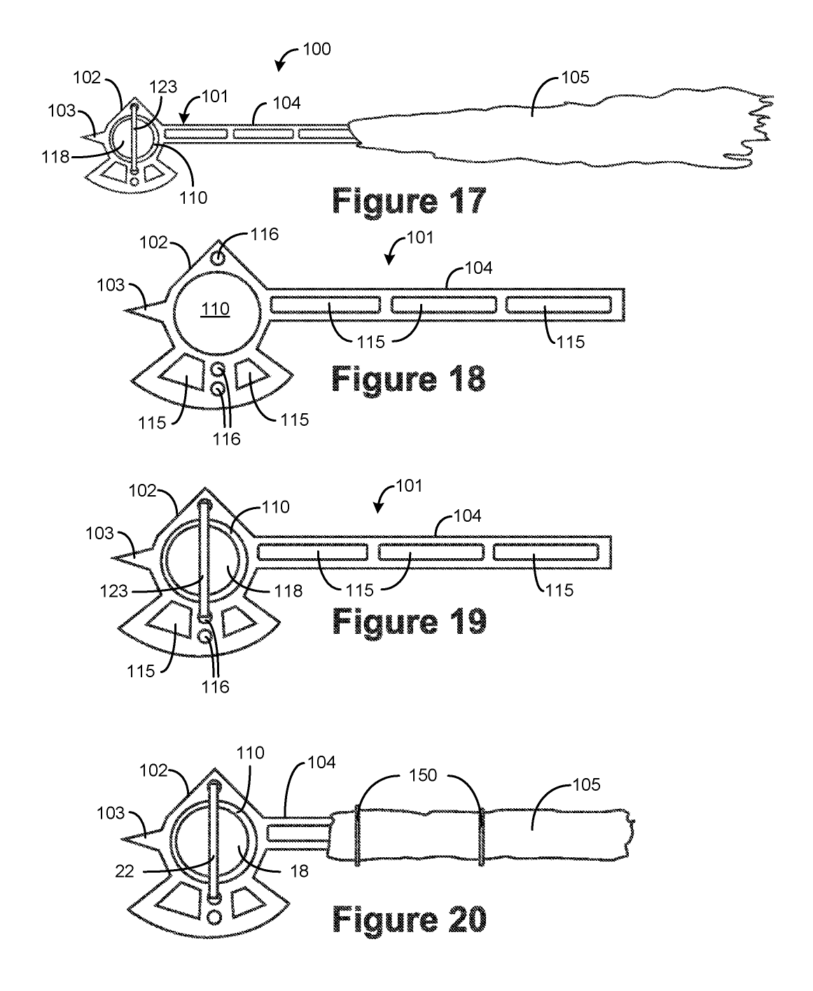

FIG. 17 depicts an exemplary embodiment of a VATO axe 100 according to another aspect of the present disclosure. The VATO axe 100 comprises an axe frame assembly 101 having a head 102 and a handle 104. In one embodiment, the head 102 has one or more sharp points 103 located on a forward end of the head 102 for piercing a target. The VATO axe 100 further comprises a stabilizing assembly 105 coupled to a rear end of the handle 104, and a spherical weight 118 positioned within an opening 110 of the axe frame assembly 101. The spherical weight 118 is retained within the opening 110 via one or more retaining pieces 123, such as, for example, flexible wire rods. A majority of the weight of the VATO axe 100 is located in the spherical weight 118. Such weight distribution allows the VATO axe 100 to fly in a straight path based upon the trajectory of the spherical weight 118. The spherical weight 118 spins and rotates freely within the opening 110 in order to allow the axe frame assembly 101 and the stabilizing assembly 105 to independently align themselves with the trajectory of the spherical weight 118 while the VATO axe 100 is in flight. Accordingly, the sharp points 103 of the head 102 remain in a forward position while the VATO axe 100 is in flight.

FIG. 18 depicts the axe frame assembly 101 of FIG. 17. The axe frame assembly 101 comprises the head 102, the one or more sharp points 103, and the handle 104. The assembly 101 has the opening 110 for receiving the spherical weight 118 (FIG. 17). In one embodiment, the axe frame assembly 101 is formed from one solid piece of material, such as, for example, steel. However, the axe frame assembly 101 may comprise more than one piece and different materials in other embodiments. The assembly 101 of FIG. 18 has a plurality of openings 115 for reducing the overall weight of the assembly 101 such that the spherical weight 18 makes up a larger portion of the overall weight of the VATO axe 100. The assembly 101 also has a plurality of holes 116 for receiving the retaining pieces 123 (FIG. 17).

FIG. 19 depicts the spherical weight 118 of FIG. 17 secured within the opening 110 of the axe frame assembly 101. The spherical weight 118 is retained within the opening 110 via the retaining pieces 123. In one embodiment, the retaining pieces 123 are secured to the axe frame assembly 101 by inserting the retaining pieces 123 into holes 116 around the spherical weight 118. However, other methods for securing the retaining pieces 123 to the assembly 101 are possible in other embodiments. The axe frame assembly 101 may be used in the same way as a conventional axe or may be thrown such that the points 103 are always oriented towards the target (not shown).

FIG. 20 depicts the VATO axe 100 of FIG. 17 with the stabilizing assembly 105 in a stowed position. In one embodiment, the stabilizing assembly 105 may be folded up around the handle 104 and used as a handle grip. In such embodiment, the stabilizing assembly 105 is held in position by one or more retaining clips 150. Thus, the retaining clips 150 retain the assembly 105 in the stowed position in order to facilitate use of the VATO axe 100 as a conventional axe. When throwing the VATO axe 100 at a target is desired, the retaining clips 150 are removed thereby freeing the stabilizing assembly 105. When the VATO axe 100 is thrown, the stabilizing assembly 105 produces aerodynamic drag causing the points 103 to remain oriented in a forward position with respect to the trajectory of the VATO axe 100, as set forth above. Accordingly, a VATO axe 100 which may be used in the same manner as a conventional axe or thrown without rotating end over end is provided.

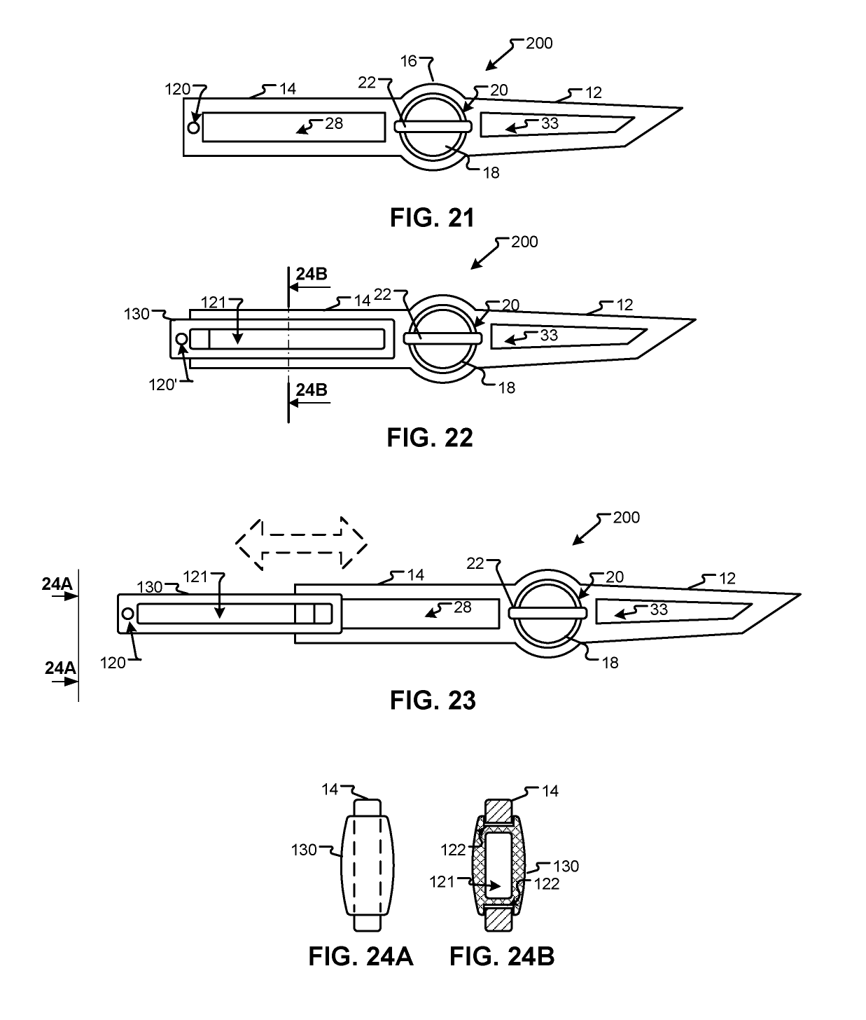

FIG. 21 a VATO knife 200 in accordance with another embodiment of the present disclosure. In this embodiment, VATO knife 200 comprises the blade 12, in which is defined an opening 33. The blade 12 extends from the handle 14 in which a generally rectangular, elongated opening 28 is also defined. Interposed between the blade 12 and the handle 14, a body section 16 comprises the circular opening 20 dimensioned to receive the spherical weight 18. The circular opening 20 and the spherical weight 18 are dimensioned to allow the spherical weight to rotate freely therein. The spherical weight 18 is retained within the circular opening 20 with retaining pieces 123 as described above. Again the blade opening 33 and handle opening 28 serve to reduce the weight on either end of the knife 10, moving the knife's center of gravity to the body region 16.

With reference to FIG. 22, the VATO 200 comprises a moveable attachment member 130. The movable attachment member 130 is slidably engaged with the handle 14 is retained within the elongated opening 28. The movable attachment member 130 may also comprise an elongated opening 121 to help reduce weight, keeping the center of gravity toward the spherical weight 18.

With reference to FIG. 23, the handle 14 may feature longitudinal grooves 122 for receiving opposing interior edges that define the rectangular opening 28, allowing the movable attachment member 130 to slide longitudinally with respect to the VATO 200. The movable attachment member 130 further comprises an attachment opening 120 defined in a portion of the member 130 near the rearward end thereof.

FIG. 24A depicts an end view of the VATO 200. The end view depicts the handle 14 interfacing with the moveable attachment member 130. Further, FIG. 24B is a cross-sectional view of the handle 14. FIG. 24B depicts the handle 14 interfacing with the longitudinal grooves 122.

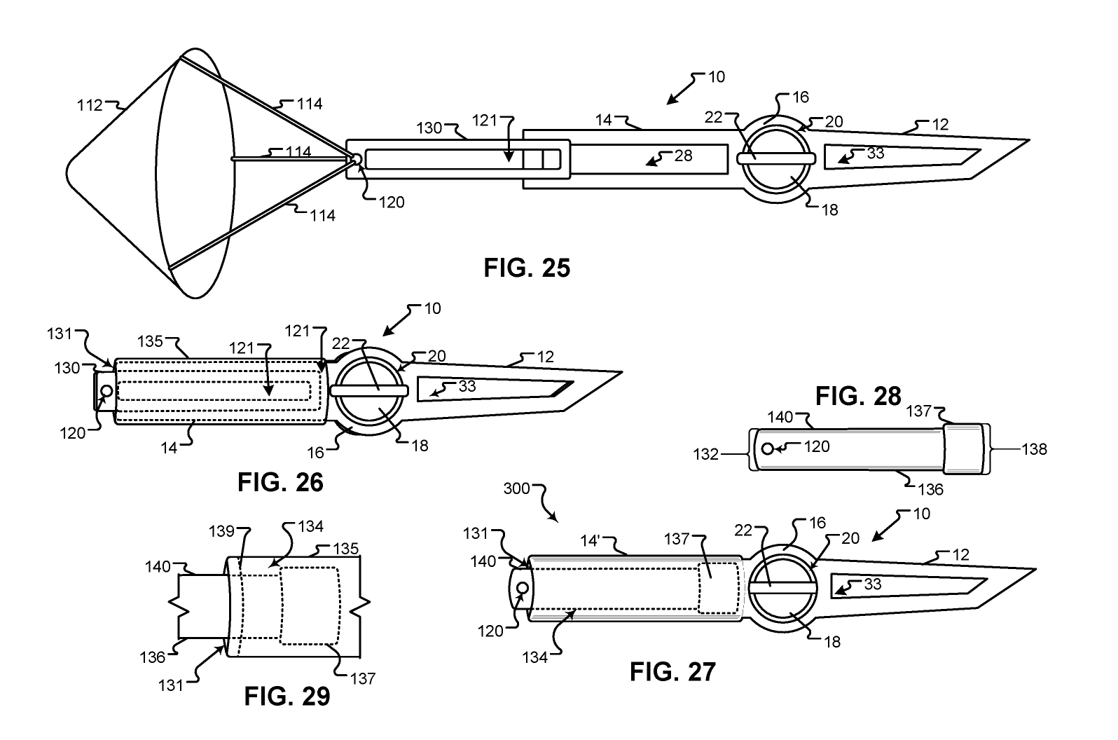

FIG. 25 depicts the VATO 200 coupled to a drogue chute 112. In this regard, the drogue chute 112 is attached by a plurality of cords 114 to the movable attachment member 130 via the attachment opening 120. In flight the drogue chute 112 prevents rotation of the VATO 200, allowing the forward point of the VATO 200 to be oriented toward a target.

FIG. 26 shows another embodiment of the VATO 200. In the embodiment depicted, the VATO 200 further comprises a hollow cylindrical tube 135 defining a cylindrical interior chamber. The interior chamber houses the moveable attachment member 130. The tube 135 has an open end 131 at the rear of the VATO 200 in which the moveable attachment member 130 is inserted. In such an embodiment, the drogue chute 112 (FIG. 25) and cords 114 (FIG. 25) may be retained with the interior of the hollow tube 135.

FIG. 27 depicts another VATO 300 in accordance with an embodiment of the present disclosure. In the embodiment depicted, the handle 14 is a cylindrical hollow tube defining a cylindrical interior chamber 134 and extending rearwardly from the knife body 16 just behind circular opening 20 and having a rearward open end 131. Note that the handle 14 may be integrally formed with the knife 10 or attached to the knife body 16 by the frontward end by, for example, welding.

The VATO 300 comprises a generally cylindrical movable attachment rod 140. The moveable attachment rod 140 is slidably housed within the interior chamber 134 of the handle 14.

With reference to FIG. 28, the attachment rod 140 comprises an end 137 disposed toward the front end of the chamber. The attachment rod 140 has a first diameter 138 that is less than the diameter of the interior chamber 134. A shaft 136 extends rearwardly from the frontward end 137 and has a second diameter 132 that is less than the first diameter 138.

With reference to FIG. 29, the open end 131 (FIG. 27) of the handle 14 is configured with an annular lip 139 that reduces the diameter of the interior chamber 134 such that it is less than the first diameter 138. Accordingly, the movable attachment rod 140 may slide longitudinally within the interior chamber 134, but is prevented from fully exiting the chamber 134 when the frontward end 137 having the first diameter 138 engages the lip 139. The rearward end of the movable attachment member 130′ includes the attachment opening 120 for attaching the drogue chute 112 as described above.

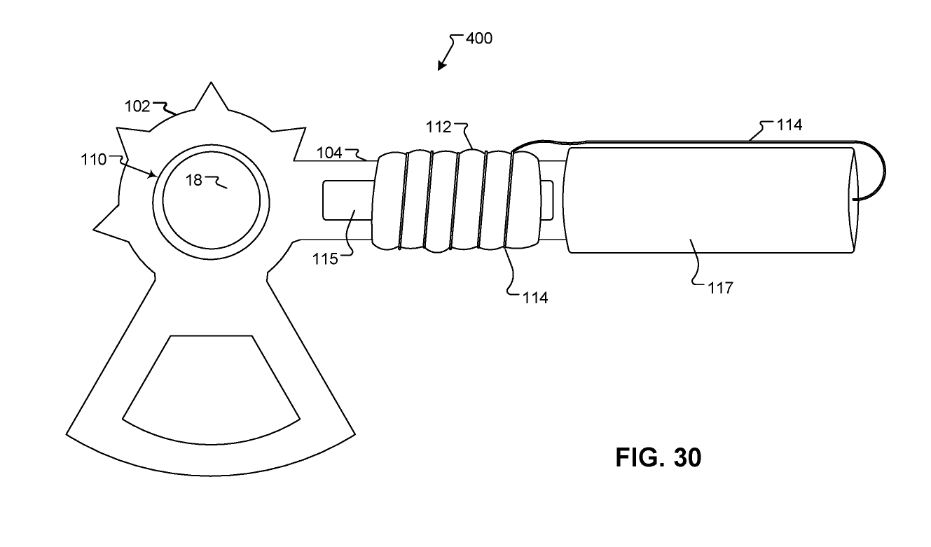

FIG. 30 depicts a VATO axe 400 in accordance with an embodiment of the present disclosure. The VATO axe 400 is substantially similar to the VATO axe 100 described with reference to FIGS. 17-20. However, the VATO axe 400 is configured and arranged with a drogue chute as described hereinabove. The VATO axe 400 includes a handle 104 with an axe head 102 in which is defined a circular opening 110 for receiving a spherical weight 18 and retained therein as described above. The handle 104 preferably includes openings 115 insuring that the center of gravity is near the axe head 102.

The handle 114 comprises a cover 117 that is generally cylindrical in which a drogue chute (not shown) may be stowed. The drogue shoot may be coupled to a plurality of cords, which are in turn coupled to the handle 104.

Now, therefore, the following is claimed:

1. A velocity aligned throwable object (VATO), comprising:
a handle having a first end and a second end;
a blade extending from the first end of the handle;
a moveable attachment member slidably engaging the handle; and
a spherical weight positioned within an opening near the second end of the handle, wherein the spherical weight rotates within the opening independently from the blade, the handle and the moveable attachment member.

2. The VATO of claim 1, further comprising at least one retaining piece coupled to the VATO, wherein the retaining piece is configured to retain the spherical weight within the opening.

3. The VATO of claim 1, wherein the blade and the handle are formed from a single piece of metal.

4. The VATO of claim 3, wherein the blade and the handle comprise steel.

5. The VATO of claim 1, wherein the blade comprises an opening that reduces weight of the VATO and moves the center of gravity to the spherical weight.

6. The VATO of claim 5, wherein the handle comprises a substantially rectangular opening that reduces weight of the VATO and moves the center of gravity to the spherical weight.

7. The VATO of claim 1, wherein the moveable attachment member comprises an elongated opening that reduces weight and moves the center of gravity to the spherical weight.

8. The VATO of claim 1, wherein the handle comprises longitudinal grooves for receiving opposing interior edges that define a rectangular opening in the handle.

9. The VATO of claim 8, wherein the moveable attachment member slidably engages the opposing interior edges so that the moveable attachment member can be extended outwardly from the handle.

10. The VATO of claim 1, wherein the movable attachment member comprises an attachment opening in a rearward end of the movable attachment member.

11. The VATO of claim 10, wherein a drogue chute is coupled to the attachment opening of the movable attachment member.

12. The VATO of claim 11, wherein one or more cords couple the drogue chute to the opening of the movable attachment member.

13. The VATO of claim 1, further comprising a hollow cylindrical tube defining a cylindrical interior chamber.

14. The VATO of claim 13, wherein the cylindrical interior chamber houses the movable attachment member.

15. The VATO of claim 14, wherein the hollow cylindrical tube has an open end at a rear end of the VATO.

16. The VATO of claim 15, wherein the movable attachment member is inserted into the open end.

17. The VATO of claim 16, wherein a drogue chute and cords are retained within the cylindrical interior housing.

18. The VATO of claim 1, wherein the handle is a cylindrical hollow tube defining a cylindrical interior chamber that extends rearwardly from the spherical weight and having a rearward open end.

19. The VATO of claim 18, further comprising a cylindrical movable attachment rod slidably housed within the cylindrical interior chamber.

20. The VATO of claim 19, wherein the movable attachment rod comprises a first end disposed toward the front end of the cylindrical interior chamber and having a first diameter that is less than a second diameter of the cylindrical interior chamber such that the movable attachment rod may slide longitudinally in the cylindrical interior chamber but is prevented from fully exiting the chamber by a lip of the cylindrical interior chamber.
